(19) United States
(12) Patent Application Publication
(10) Pub. No.: US 2004/0143654 A1
(43) Pub. Date: Jul. 22, 2004

(54) Node location management in a distributed computer system

(76) Inventors: Didier Poirot, Plaisir (FR); Jacques Cerba, Grenoble (FR); Jean-Pascal Mazzilli, Eybens (FR)

Correspondence Address: WAGNER, MURABITO & HAO LLP, Third Floor, Two North Market Street, San Jose, CA, 95113, US

(21) Appl. No.: 10/609,208

(22) Filed: Jun. 27, 2003

(30) Foreign Application Priority Data
Jun. 28, 2002 (FR) 0208079

(51) Int. Cl. G06F 15/173

(52) U.S. Cl. 709/223

(57) ABSTRACT

A method and system of node location management in a distributed node system. A management server of a distributed node system includes a table manager, a node location manager, and a client manager. The table manager is adapted to load a first table including various information for node identifiers. The information includes: a location identifier, a hardware identifier, and configuration parameters. The node location manager is adapted to detect a new hardware identifier for a location identifier and to send a modification message to the table manager. The modification message comprises a new hardware identifier for a location identifier. Further, the table manager is adapted to update the first table responsive to a such modification message. The client manager is adapted to generate at least a second table in a client server according to the first table and to update the second table when the first table is updated.

### RELATED APPLICATION

This Application claims priority to French Patent Application, Number 0208079, filed on Jun. 28, 2002, in the name of SUN Microsystems, Inc., which application is hereby incorporated by reference.

### BACKGROUND OF THE INVENTION

1. Field of the Invention

The present invention relates to the field of distributed computer systems. Specifically, embodiments of the present invention relate to locating where a node is in a distributed computer system and managing based on node location.

2. Background Art

A distributed computer system comprises nodes associated to boards connected between them with e.g., Ethernet links using Ethernet switches and/or cPCl buses. In a distributed computer system, it is highly important to assign a specific role to a given node, e.g., to assign specific configuration parameters. For example, one node may be assigned to run an application “A” on a “SPARC/Solaris” (SPARC is a Trademark of SPARC International Inc.) board and another node may be assigned to run another application “B” on a “Intel/Linux” board. To achieve this goal, the location of the nodes in the distributed computer system is important.

### SUMMARY OF THE INVENTION

The present invention provides a method and system of managing based on node location in a distributed node system. In one embodiment, a management server of a distributed node system comprises a table manager, a node location manager, and a client manager. The table manager is adapted to load a first table comprising various information for node identifiers. The information comprises: a location identifier, a hardware identifier, and configuration parameters. The node location manager is adapted to detect a new hardware identifier for a location identifier and to send a modification message to the table manager. The modification message comprises a new hardware identifier for a location identifier. Further, the table manager is adapted to update the first table responsive to such a modification message. The client manager is adapted to generate at least a second table in a client server according to the first table and to update the second table when the first table is updated.

Another embodiment in accordance with the present invention provides a method of node location management in a distributed node system. The method comprises: loading a first table comprising, for one or more node identifiers, a location identifier, a hardware identifier, and configuration parameters. The method also comprises detecting a new hardware identifier for the location identifier. The method also comprises updating the first table responsive to the new hardware identifier for a location identifier. The method also comprises generating at least a second table in a client server according to the first table and updating the second table when the first table is updated.

Embodiments of the present invention provides these advantages and others not specifically mentioned above but described in the sections to follow.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 represents a distributed computer system comprising nodes and switches.

FIG. 2 is a functional diagram of a distributed computer system using a network protocol module.

FIG. 3 is a table of IP addresses stored according to a network protocol module.

FIG. 4 is a functional diagram of a distributed computer system using a server according to an embodiment of the present invention.

FIG. 5 is a functional diagram of a server according to an embodiment of the present invention.

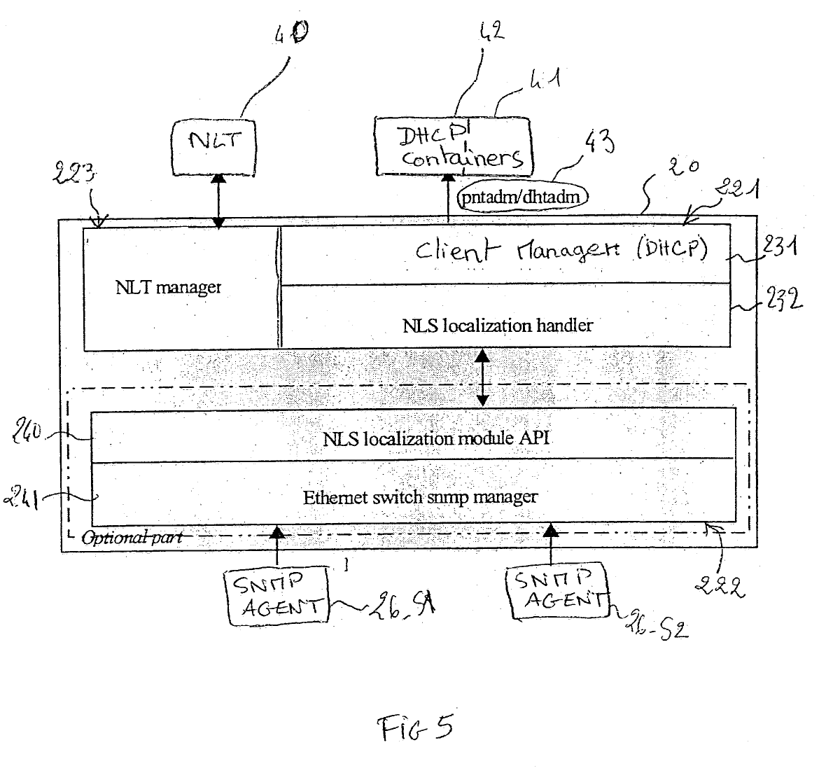

FIG. 6 is a table of node locations generated by a server according to an embodiment of the present invention.

FIG. 7 is a flowchart illustrating a process of initializing operations of a server according to an embodiment of the present invention.

FIG. 8 is a flowchart illustrating a process of running operations of a server according to an embodiment of the present invention.

FIG. 9 is a flowchart illustrating a process of generating a local table in case of a dynamic node location and the use of a manageable switch, in accordance with an embodiment of the present invention.

FIG. 10 is a flowchart illustrating a process of updating a local table, in accordance with an embodiment of the present invention.

### DETAILED DESCRIPTION OF THE INVENTION

In the following detailed description of the present invention, node location management of computers in distributed computer system, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

Embodiments in accordance with the present invention are implemented with software code. Embodiments in accordance with the present invention make available the software code on any appropriate computer-readable medium. The expression “computer-readable medium” includes a storage medium such as magnetic or optic, as well as a transmission medium such as a digital or analog signal.

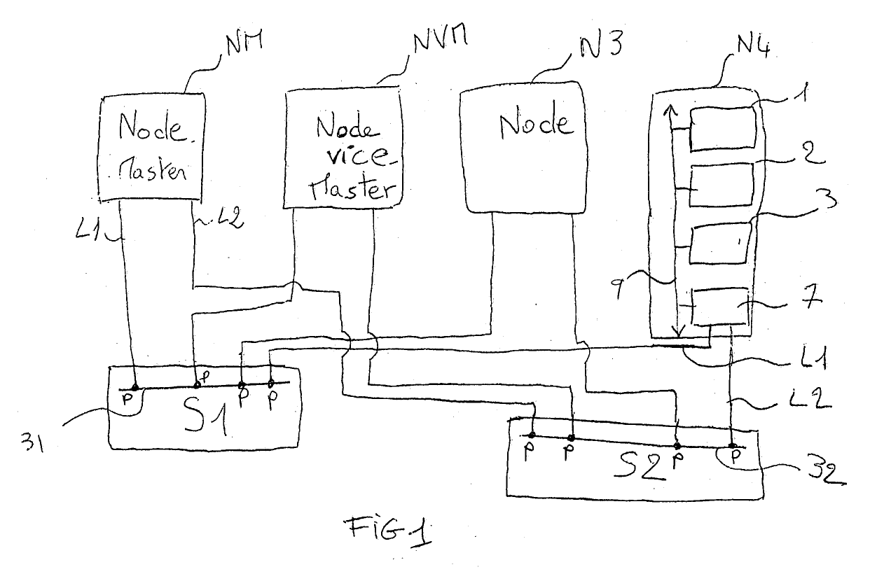

This invention may be implemented in a network comprising computer systems. The hardware of such computer systems is for example as shown in FIG. 1, where in the computer system N4:

1 is a processor, e.g., an Ultra-Sparc (SPARC is a Trademark of SPARC International Inc.);

2 is a program memory, e.g., an EPROM for BIOS;

3 is a working memory for software, data and the like, e.g., a RAM of any suitable technology (SDRAM for example); and

7 is a network interface device connected to communication links L1 and L2, each in communication with a switch S1, S2 to enable communication with other computers.

Network interface device 7 may be an Ethernet device, a serial line device, or an ATM device, inter alia. Links L1 and L2 may be based on wire cables, fiber optics, or radio-communications, for example.

The computer system, also called node Ni, may be a node amongst a group of nodes in a distributed computer system. Some nodes may further comprise a mass memory, e.g., one or more hard disks. The nodes having hard disk are designated as diskfull and other nodes having no hard disk are designated as diskless.

Data may be exchanged between the components of FIG. 1 through a bus system 9, schematically shown as a single bus for simplification of the drawing. As is known, bus systems may often include a processor bus, e.g., of the PCI type, connected via appropriate bridges to e.g., an ISA bus and/or an SCSI bus.

Node N4 is one of the nodes of the cluster NM, NVM, N3. For reliability reasons, the cluster may comprise a master node NM and a vice-masternode NVM adapted to manage the nodes of the cluster. When informed about the master node failure, the vice-master node may replace the failed master node in its role.

References to the drawings in the following description will use two different indexes or suffixes i and j, each of which may take anyone of the values: {NM, NVM, N3 . . . , Nn} n being the number of nodes in the cluster. In the foregoing description, a switch is only an example of a connection entity for nodes on the network, cPCl buses may also be used.

Each node Ni is connected to a network 31, e.g., the Ethernet network, which may be also the Internet network. The node Ni is coupled to a switch S1, e.g., an Ethernet switch, capable of interconnecting the node Ni with other nodes Nj through the network 31. The switch comprises several ports P, each being capable of connecting a node Ni to the switch S1 via a link L1. In an embodiment of a switch, the number of ports per switch is limited, e.g., to 24 ports in some switch technologies. Several switches may be linked together in order to increase the number of nodes connected to the network, e.g., the Ethernet network. By way of example only, the switch may be called an Ethernet switch if the physical network is an Ethernet network. Indeed, different switch types exist such as an Ethernet switch or an Internet switch could also be called an IP switch. Each switch has an identifier:

for an Ethernet switch, the identifier is, e.g., a MAC address being an Ethernet address or an IP address for administration;

for an IP switch, the identifier is, e.g., an IP address.

Each switch port has P an identifier, e.g., a port number being generally an integer or an Ethernet port address. In the following description, an Ethernet switch is used but the invention is not restricted to this switch type.

If desired, for availability reasons, the network 31 may be also redundant. Thus, the links L1 may be redundant: nodes Ni of the cluster are connected to a second network 32 via links L2 using a redundant switch, such as a switch S2. This redundant network 32 is adapted to interconnect a node Ni with another node Nj through the redundant network 32. For example, if node Ni sends a packet to node Nj, the packet may be therefore duplicated to be sent on both networks 31, 32. In fact, the second network 32 for a node may be used in parallel with the first network 31 or replace it in case of first network failure.

Also, as an example, it is assumed that packets are generally built throughout the network in accordance with a transport protocol and a presentation protocol, e.g., the Ethernet Protocol and the Internet Protocol. Corresponding IP addresses are converted into Ethernet addresses on Ethernet network.

The following is a description of a boot of a node. When a new node is inserted in the system at initialization time or at any other time, the node is booted according to its software load configuration parameters. Particularly, this boot enables a diskless node to obtain its link addresses from a diskfull node.

At initialization time, each node executes an initialization software providing various capabilities such as low level hardware configuration, low level hardware tests, operating system loading configuration, boot file configuration. On Sun hardware, such software may be called Open Boot Prom (OBP).

According to the configuration of this initialization software (e.g., OBP), it launches a program to allow diskfull nodes to boot from their local disk or from the network, and to allow diskless nodes to boot from the network. To boot from the network means to boot from the disk of a remote diskfull node in the network.

In the context of this invention, boot of diskless nodes is particularly considered. When a diskless node boots, its initialization software (e.g., OBP) sends a broadcast request (e.g., DHCP discover) containing an identifier of the hardware of the node, e.g., its board Ethernet MAC address, a board serial number, according to a particular protocol, e.g., DHCP. Thus, all nodes may receive this request.

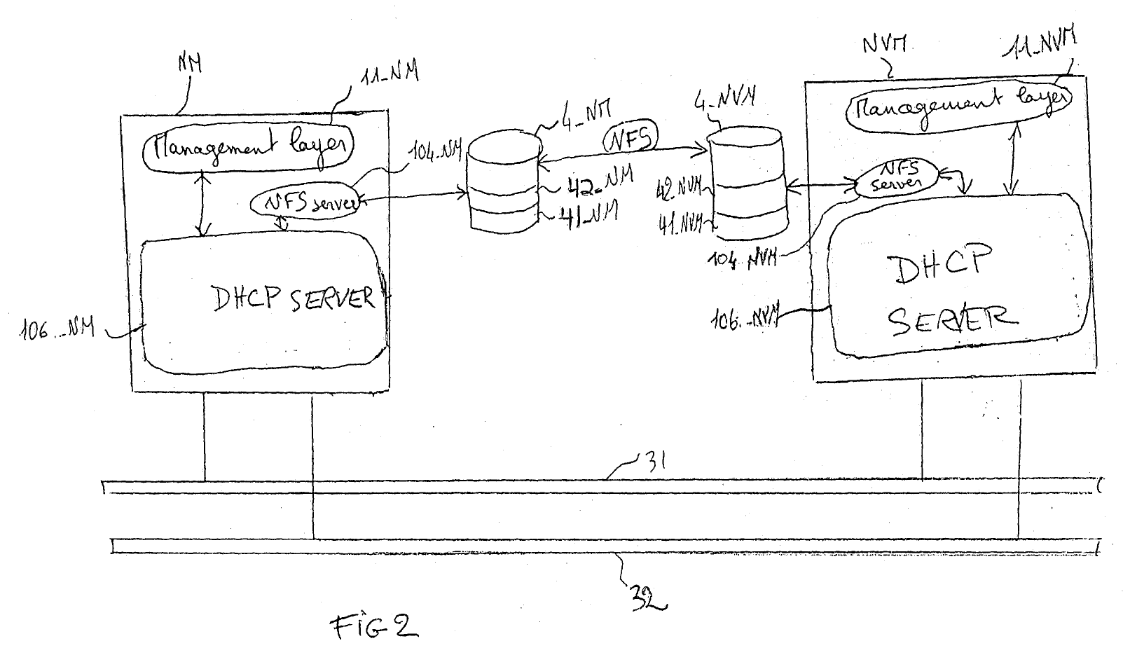

FIG. 2 illustrates the prior art of the management of a DHCP server. As illustrated in FIG. 2, a diskfull node comprises a DHCP server 106 adapted to reply to this request by providing:

its address as the DHCP server 106,

the file path name of the diskfull node to download the default boot file to the diskless node.

This DHCP server 106 replies also by providing an address, e.g., IP address, becoming the IP address of the diskless node. Each data or resources may be contained in a disk 4, more precisely in portions of disk called DHCP containers 41 and 42.

Several diskfull nodes have a DHCP server 106 adapted to reply to a request of a diskless node, called a client's request. A function exported by a public module of a service provider layer of DHCP server 106 allows two DHCP servers 106 to run on two separated diskfull nodes and sharing the same DHCP containers 41 and 42 on the disk 4-NM. The second disk 4-NVM also comprises mirrored DHCP containers 41 and 42 being used in case, for example, of master node failure.

Thus, each diskfull node comprises a DHCP function 106, also called the DHCP server 106, composed of a core DHCP server, a configuration file tool and a public module e.g., NHRBS public module (Sun Netra Highly Reliable Boot Service).

The configuration file tool is adapted to configure the core DHCP server so as to use the public module. The public module may be a dynamic library automatically loaded at run-time by the core DHCP server.

As illustrated in FIG. 2, the DHCP server 106 is linked to a disk 4 having containers, e.g., containers 41,42, via an NFS server 104 (Network File System). The configuration file tool indicates the link level interfaces of the diskfull node to which the DHCP server 106 is connected and that this DHCP server 106 monitors. Thus, one container is designated for each link level interface monitored by the DHCP server 106. This container is called the network container 41. It may contain the data corresponding to a request received at the link level interface of the diskfull node. Its address may indicate this link level interface address. Indeed, there may be one network container per subnet managed by the DHCP server 106. Typically, a single server running on a system equipped with two network interfaces (hme0 and hme1, for example, on the Netra systems), can manage two DHCP network containers, one for each interface. Table I illustrates an example of a DHCP network container.

TABLE I
$ cat /SUNwcgha/remote/var/dhcp/SUNwnhrbsl_10_1_1_0
# SUNWnhrbsl_10_1_1_0#
10.1.1.12|00|01|10.1.1.1|4294967295|2774498845436936197|pn12|netra-
t1-9
10.1.1.11|00|01|10.1.1.1|4294967295|2774498845436936198|pn11|netra-
t1-8
10.1.1.10|01080020F996DA|01|10.1.1.1|4294967295|
13030884046819819544|pn10|netra-t1-7

In the exemplary DHCP network container, the network containers used by the SUNnhrbs module are named: SUNWnhrbsN-A-B-C-D where:

N is the version of the public module managing the container. (e.g., 1 for NHAS 2.0); and

A-B-C-D is the classical ASCII decimal representation for the subnet corresponding to the network interface.

For example, if interface hme0 is connected to subnet 10.1.1.0 and hme1 to subnet 10.1.2.0, the network containers will be named: SUNWnhrbs1_{—}10_{—}1_{—}1_{—}0 and—SUNWnhrbs1_{—}10_{—}1_{—}2_{—}0. The content of the network containers used by SUNWnhrbs may be compatible with the ones used by the public module of the service provider layer.

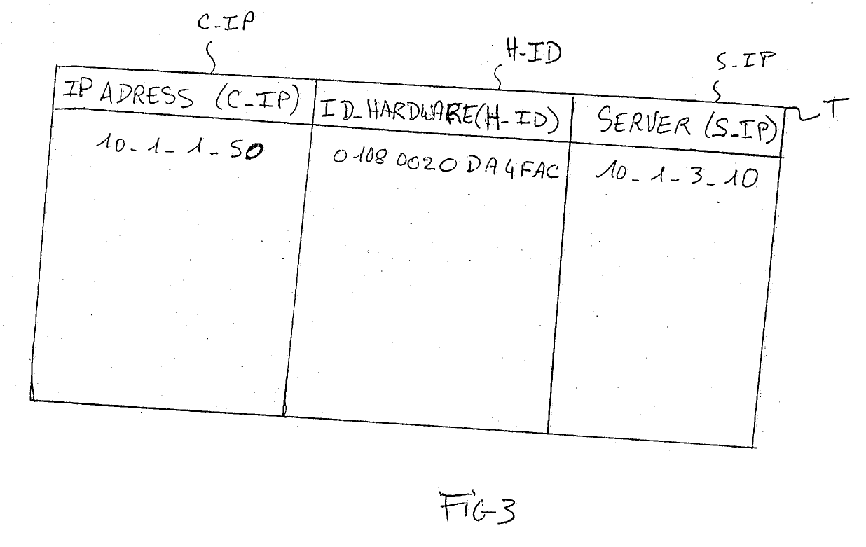

These network containers 41 are used by the public module to store data associated in a table T as illustrated in FIG. 3.

The network containers 41 may contain entries having different fields such as:

a C-IP field containing the IP address managed by the DHCP server,

an H-ID field containing, when the IP address is assigned to a client node, the identifier of the hardware associated to the node, e.g., the MAC address of the node,

an S-IP field containing the IP address of the DHCP server owning this entry, e.g., the server which manages it.

Other fields may be added to specify other data related to the entry.

The content of these network containers 41 may be rendered compatible with the containers used for other modules. In the prior art, the DHCP network container 41 and the dhcptab container 42 are configured by the configuration file tool. Moreover, in the prior art, the core DHCP server is composed of at least an application layer comprising applications to update DHCP containers.

The previous example of a DHCP network container is that of a dhcp network container configured by the configuration file tool and is for the subnetwork 10_{—}1_{—}1_{—}0. The entry concerns the IP address 10.1.1.10 for a node, which has a hardware identifier of 01 080020F996DA.

Table II illustrates an exemplary dhcptab container. This dhcptab container contains definition for configuration parameters that can be applied to one or more network container entries.

TABLE II
$cat /SUNWcgha|remote/var/dhcp/SUNWnhrbs_dhcptab
#SUNWnhrbs1_dhcptab
#
Locale|m|15358963579193655297|:\
:UTCoffst=−18000:\
:BootSrvA=10.1.1.1:\
:BootSrvN=“cgtp-master-link-a”:\
:Subnet=255.255.255.0:
#
pn10|m|2508223517468655617|\
:Include=Locale:\
:BootFile=“inetboot.sun4u.Solaris 8”:\
:SrootNM=“cgtp-master-link-a”:\
:SrootIP4=10.1.1.1:\
:SrootPTH=“/export/home/client/netra-tl-7/root”:\
:SswapPTH=“/export/home/c1ient/netra-tl-7/swap”:\
:SswapIP4=10.1.1.1:\
:Broadcst=10.1.1.255:\
:Router=10.1.1.1:
#
pn11|m|38947692527453470731 :\
:Include=Locale:\
:BootFile=“inetboot.sun4u.Solaris 8”:\
:SrootNM=“cgtp-master-link-a”:\
:SrootIP4=10.1.1.1:\
:SrootPTH=“/export/home/client/netra-tl-8/root”:\
:SswapPTH=“/export/home/client/netra-tl-8/swap”:\
:SswapIP4=10.1.1.1:\
:Broadcst=10.1.1.255:\
:Router=10.1.1.1:
#
SbootFIL|s|11187222949365022721|vendor=SUNW.UltraSPARC-Ili-
cEngine,7,ASCII,1,0
SswapPTH|s|15424547248767238145|vendor=SUNW.UltraSPARC-Ili-
cEngine,6,ASCII,1,0
SswapIP4|s|6900077579085021185|vendor=SUNW.UltraSPARC-Ili-
cEngine,5,IP,1,0
SrootPTH|s|558981156249691750|vendor=SUNW.UltraSPARC-Ili-
cEngine,4,ASCII,1,0
SrootNM|s|17526602374842417153|vendor=SUNW.UltraSPARC-Ili-
cEngine,3,ASCII,1,0
SrootIP4|s|1126181381819334657|vendor=SUNW.UltraSPARC-Ili-
cEngine,2,IP,1,1
SrootOpt|s|9453337092827381761|vendor=SUNW.UltraSPARC-Ili-
cEngine,1,ASCII,1,0

The containers of diskfull nodes may be shared by at least two diskfull nodes, the master node and the vice-master node. The diskfull nodes may use an NFS network (Network File System).

Amongst diskfull nodes, the master NM and vice-master NVM nodes of the cluster are to be designated initially and at every boot of the system. Moreover, in the prior art, the DHCP server is linked to the management layer of the node. Thus, when the management layer 11-NM detects the master node NM has failed, the vice-master NVM is designated as the new master node of the cluster. The management layer 11-NVM detects the vice-master node as the current master node and the DHCP server of the node is informed.

The DHCP server is adapted to assign to a booting node, based on its board hardware identifier, an available IP address indicating configuration parameters. This assignment is random. If the node fails and re-boots, the DHCP server may assign to this node another available IP address. Thus, if a node re-boots, the IP address of this node may change, causing a change of configuration parameters, which provokes compatibility problems between the board type, the operating system, and the applications running on the board. Moreover, the board of the node may be changed, thus providing a new board hardware identifier. A requirement is to provide personalized configuration parameters for a node, even in case of node re-boot or board change.

To solve these problems, embodiments of the present invention provide a node location server to manage services requiring node location, such as the DHCP server.

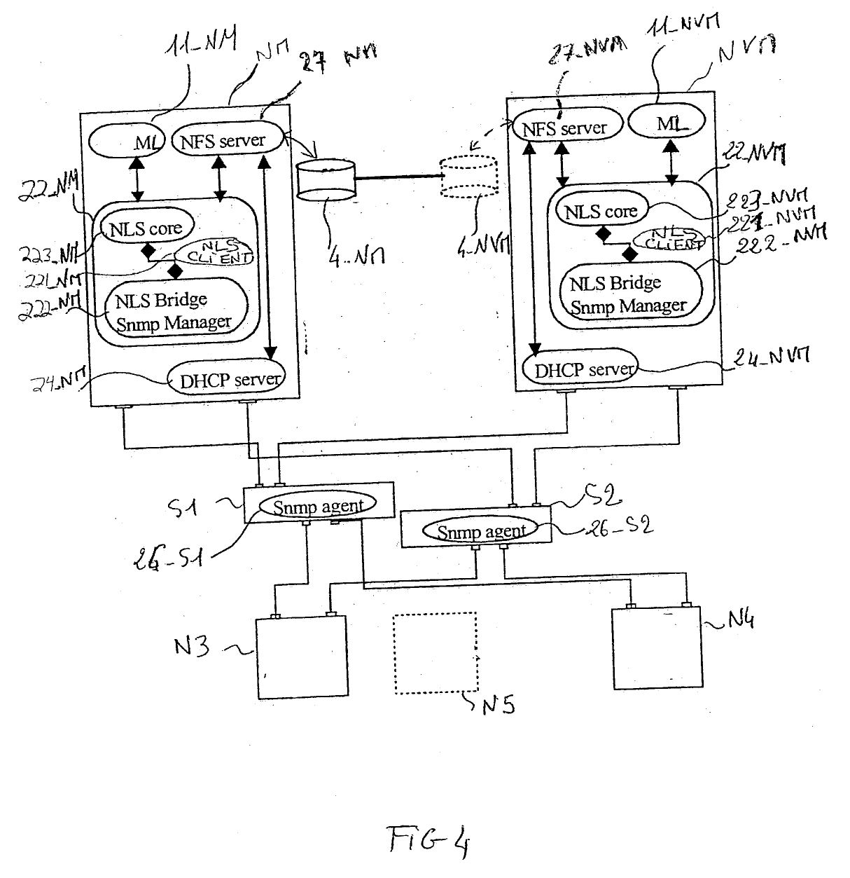

FIG. 4 illustrates an exemplary cluster supporting redundancy of master node for reliability, according to an embodiment of the present invention. The diskfull nodes of the cluster, being the master and the vice-master nodes NM and NVM, comprise a management layer 11 connected to a node location server 22. This management layer 11 is adapted to notify the node location server (NLS) 22 about the elected master node or the master node failure. The node location server (NLS) 22 comprises an NLS core 223 being a table manager, an NLS client 221 and a node location manager 222, e.g., a SNMP manager.

The NLS core 223 manages a table, the Node Location Table (NLT), containing information for each node's physical location, e.g., Ethernet switch port number and Ethernet board MAC addresses. This table may be cached in memory 4, e.g., a cache memory, more particularly in a portion 40 of this cache memory, and may reside in a mirrored file system for redundancy acceded only through a NFS server 27 locally.

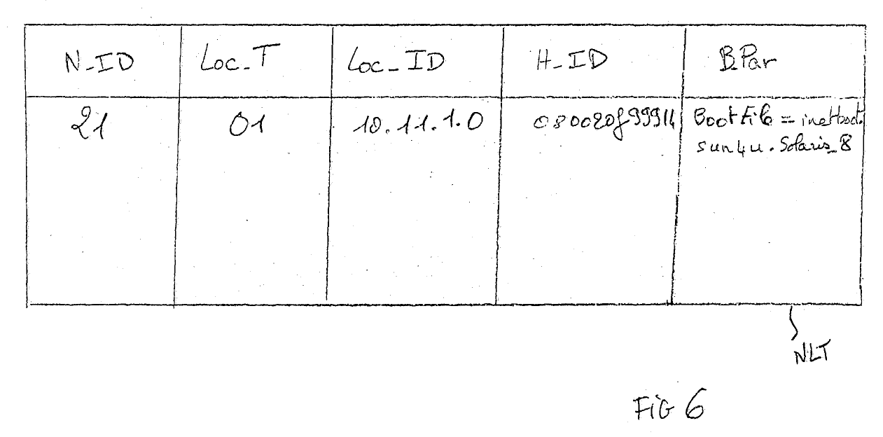

The NLS client 221 comprises a client manager 231 connected to the services requiring node location as the DHCP server 24. As described hereinafter, the node location server 22 is adapted to start at initialization time before the DHCP server 24. The node location server 22 is adapted to configure and to load the node location table NLT as illustrated in FIG. 6 and to configure the DHCP containers 41 and 42 according to the table NLT using configuration file tool 43 of the DHCP server 24. The NLT table may be managed dynamically or statically, as seen hereinafter. Thus, the DHCP containers 41 and 42 are updated when changes appear in the NLT table.

The following is an exemplary API, according to an embodiment of the present invention:

Functions of NLS location module API:

Void nlsConfigure(String config) Pass a configuration string to the node location manager.

Void nlsFinalize( ) Properly terminate node location manager.

Void nlsInitialize( ) Initialization of node location manager

Void nlsLocalize(NlsLocinfoList locinfoList) Collect a list of location information represented by couples (loc-1D, H-1d).

Void nlsRegister(NlsLocationModuleHandler handler) Register a callback with the node location manager

Void nlsStart( ) Start location service.

Void nlsStop( ) Stop location service.

In case of a dynamic table management, the node location server 22 establishes an optional node location manager 222 using the NLS location module API 240 and nlsInitialize( ) function.

The node location manager 222 comprises a location dynamic module being e.g., an Ethernet switch SNMP manager 241 adapted to:

use a network information management protocol, e.g., the simple network management protocol (SNMP) as described in RFC 1157 (May 1990), in order to establish a connection with and to work in relation with an agent module, e.g., an agent module 26-S1 of a switch S1, using advantageously the same network information management protocol (SNMP),

request the agent module to perform network management functions defined by the SNMP protocol, such as a get-request(var) function requesting the agent module to return the value of the requested variable var, a get-next-request(var) function requesting the agent module to return the next value associated with a variable e.g., a table that contains a list of elements, the set-request(var, val) function requesting the agent module to set the value val of the requested variable var.

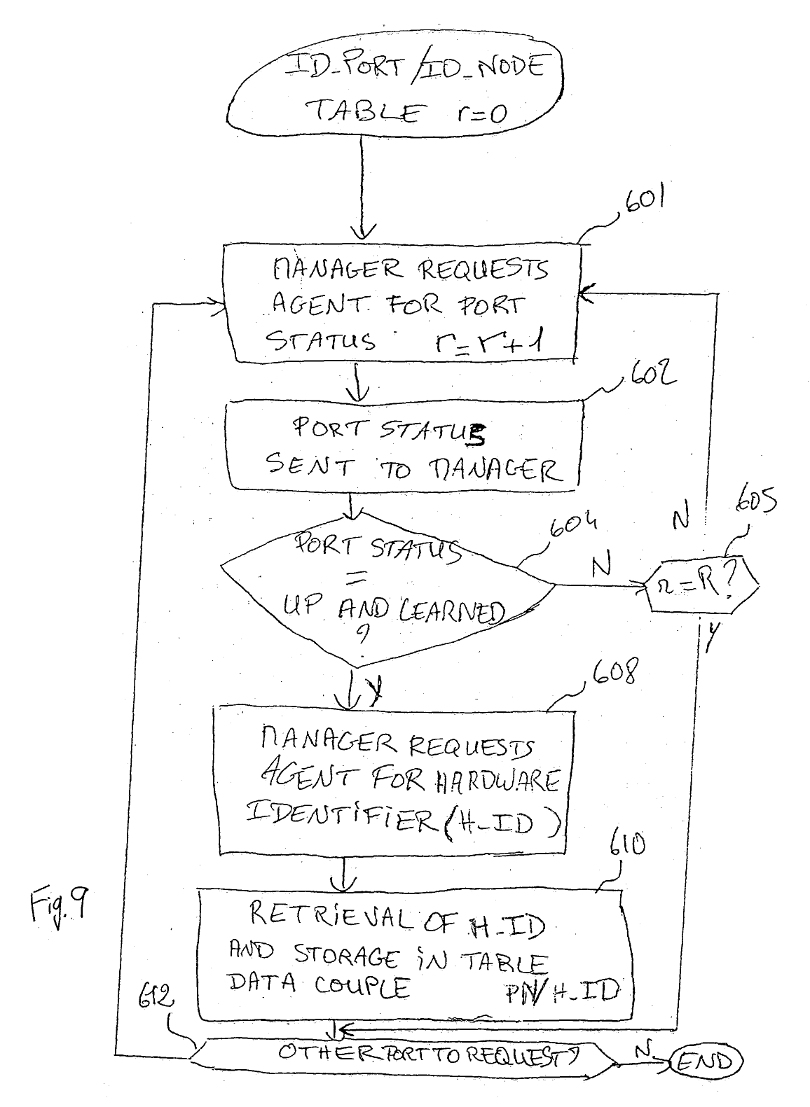

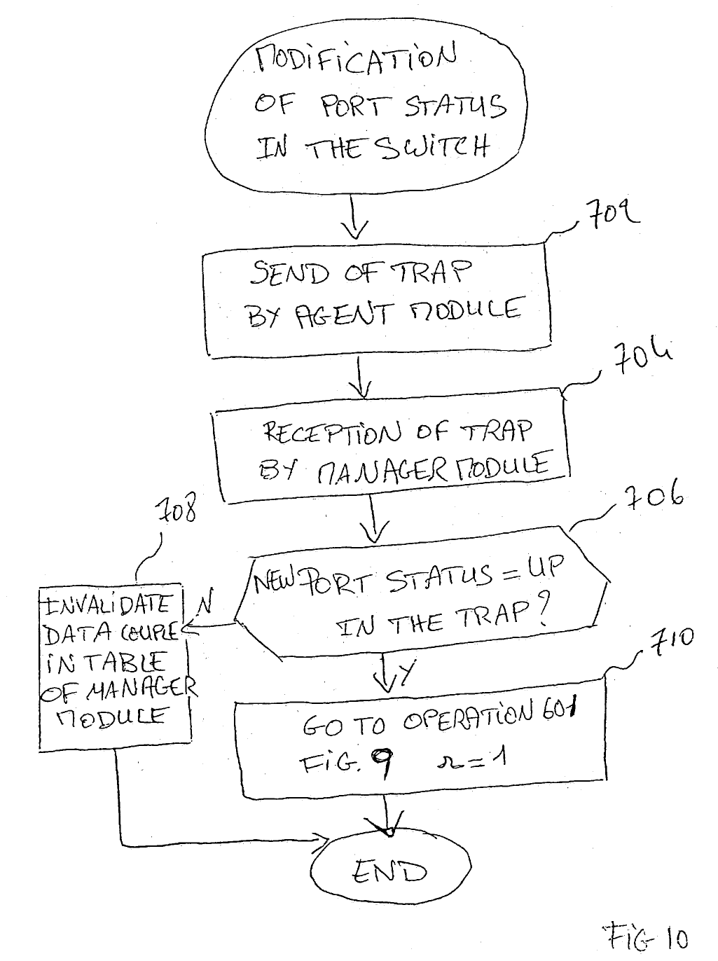

A goal of this module is to detect the active ports of switches (traffic detected) and, for each active port having a given port number, to retrieve the hardware identifier of the connected node. Thus, the Ethernet switch SNMP manager 241 develops a method to retrieve node location at runtime described in FIGS. 9 and 10. The Ethernet switch $NMP manager 241 is based on both RFC1213 (Management Information Base (MIB-11) for use with network management protocols in TCP/IP-based Internets) and RFC1493 (portion of the Management Information Base (MIB) for use with network management protocols in TCP/IP based Internets). The NLS location module API 240 is used by NLS core 223 to manage the node location manager 222. Through this NLS location module API 240 and implemented by the NLS location module, the NLS core is able to:

read the private configuration (nlsConFigure) of the location dynamic module, e.g., Ethernet switch SNMP manager 241, and initialize by essentially creating an SNMP session (nisinitialize)

to register with the location dynamic module to receive location information changes, e.g., to register a callback function to be invoked on SNMP dynamic information messages called “traps” (nisRegiste( )

to make it operational by starting it (nlsStart)

to get all necessary information (nlsLocalize) from the switches and to build an internal location table for each switch

to stop and terminate properly the Node location manager 222.

The following is exemplary NLS location handler function, in accordance with an embodiment of the present invention:

Void nisProcessLocalize(NlsLocinfo locinfo) Notify NLS core of a location information change returning (loc-ID, H-ID).

Using the exemplary nIsProcessLocalize( ) function, the NLS location handler 232 notifies the NLS core 223 of node location changes for the NLS core to update the dynamic table according to node location information changes.

FIG. 6 illustrates the NLT table providing the node's location, in accordance with an embodiment of the present invention. It may comprise the following fields:

a node identifier, being a unique number to identify the node (N-ID),

a location type (Loc-T) which can have the following values:

00: no location is required for this node. In this case, the location. Identifier and the hardware Identifier are not relevant.

01: Static location is required for this node. The location Identifier is not relevant and the hardware Identifier is set at initial configuration time.

02: Dynamic configuration is required for this node. The node location manager is configured and the hardware Identifier field is initialized to 0.

a Location identifier (Loc-ID): This identifier is location type dependent and may have the following values:

Loc-T=00:This location identifier is not relevant.

Loc-T=01: for static location, it may have the following format: subnet. Subnet is the subnet IP address configured on network interface of Ethernet address <hard-wareld>.

Loc-T=02 for dynamic policy, it may have the following meaning: id@ subnet. Id being the port number and subnet being the subnet IP address managed by the Ethernet switch for switch port-based location.

a hardware identifier (H-ID): This identifier is location type dependent and may have the following values:

Loc-T=01: for static location, it may be set with the client identifier used by OBP in the DHCP discover request.

Loc-T=02: for dynamic location, the hardware identifier is set to 0. It is filled at node location manager 222 startup time and updated at run-time if the node location server 22 detects a modification.

bootParameters (B-Par): represents the DHCP various parameters used at boot time and may include the following:

Pathname of root file system to mount, pathname of boot image file, pathname of swap file for example.

In an embodiment, the IP address of the subnet may have the following pattern 10. <clusterID>. <1/2>0.0. The <1/2> term means the term may have for value 1 or 2 a subnet or its redundant subnet. The IP address of a node may be deduced from the IP address of the subnet as it may have the following pattern: 10. <cluster ID>. <1/2>. <nodeID>. When a DHCP container is configured according to the NLT table or updated, the IP addresses of nodes are also furnished from the NLT table.

Thus, the node being on a given port may always have the same IP address and the same configuration parameters even in case of node re-boot or change of board for a node.

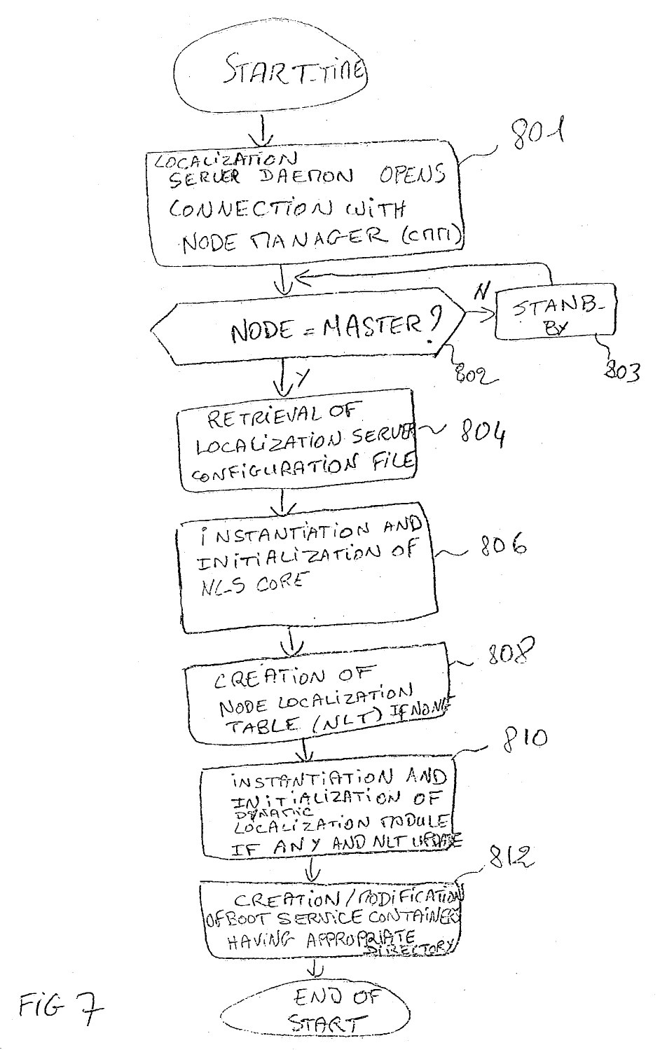

Table III illustrates an exemplary NLT table. This example illustrates three different cases. Node 20 is not bound to any hardware board and can be affected to one of the hardware boards not located. Node 21 is bound statically to the board having 080020f99914 MAC address. Node 22 is linked to the hardware board connected to port number 4 of each Ethernet switch. The MAC address used as client identifier by DHCP to boot the node is filled at node location server 22 startup time as described in flowchart of FIG. 7.

TABLE III
# SUNWnhnlt
# Node Location Table
#
# nodeId|locType|locId|hardwareId|BootParameters
#
20|00|00|00|BootFile=inetboot.sun4u.Solaris_8 : S rootPTH=/ export/root/
NMEN-C11N20:SswapPTH=/export/root/NMEN -C11- N20
21|01|10.11.1.0|080020f99914|BootFile=inetboot.sun4u.Solaris_8:
SrootPTH=/export/root/NMEN-C11-N21:SswapPTH=/export/root/
NMEN -C11-N21
21|01|10.11.2.0|080020f99915|BootFile=inetboot.sun4u.Solaris_8:
SrootPTH=/export/root/NMEN-C11-N21:SswapPTH=/export/root/
NMEN -C11-N21
22|02|04@10.11.1.0|0|BootFile=inetboot.sun4u.Solaris_8:SrootPTH=/
export/root/NMEN-C11-N22:SswapPTH=/export/root/NMEN -C11-N22
22|02|04@10.11.2.0|0|BootFile=inetboot.sun4u.Solaris_8:SrootPTH=/
export/root/NMEN-C11-N22:SswapPTH=/export/root/NMEN-C11-N22

Flowchart of FIG. 7 illustrates the start-time of the node location server, according to an embodiment of the present invention. At initialization time, an NLS daemon in charge of “NLS availability” is started on both master and vice-master nodes. The two instances of NLS daemon open a persistent connection with the CMM to get the current and receive the future cluster membership information at operation 801. Then, NLS takes two different paths, depending on whether it find itself on the Master or on the Vice-master. The node location server is started after the management layer has elected a master node. At operation 802, if the node location server is running on the master node, it offers the location service. The other one running on the vice-master node is waiting for management layer notifications at operation 803. Entering in a stand by mode, the vice-master node is only waiting for cluster membership notification. When it receives a CMM-MASTER-ELECTED notification, it checks the role assigned to the node it is running on. If it runs on the master node at operation 802, it takes the primary role by starting the NLS service.

For the node location server running on the master node, at startup time, the NLS daemon uses a general configuration file managed by NLS core, to get information about NLS service configuration at operation 804 and to instantiate and initialize NLS core by setting its configuration from this general configuration file at operation 806. Then, using the configuration information gathered previously, the Node Location Table (NLT) is loaded in memory at operation 808. If a node location manager has been configured, e.g., in the general configuration file, it is instantiated, initialized and configured with specific mandatory/optional module parameters at operation 810. Thus, it establishes a connection, an SNMP session, with a connection entity, e.g., an Ethernet switch being an SNMP agent. The node location manager callback function is registered in order to be ready to receive and process all the node location information from e.g., the SNMP agent. Then, NLS core gets, from the node location manager, the node location information and updates accordingly the NLT table in memory. From the NLT table now up to date, NLS core can create/update DHCP containers (network and dhcptab) using standard DHCP administration commands at operation 812. As described hereinabove, when a DHCP container is configured or updated according to the NLT table, the IP addresses of nodes are generated from the IP addresses of subnets furnished from the NLT table by the NLS core. These IP addresses of nodes are used for the DHCP containers configuration. The start-time illustrated in FIG. 7 then ends.

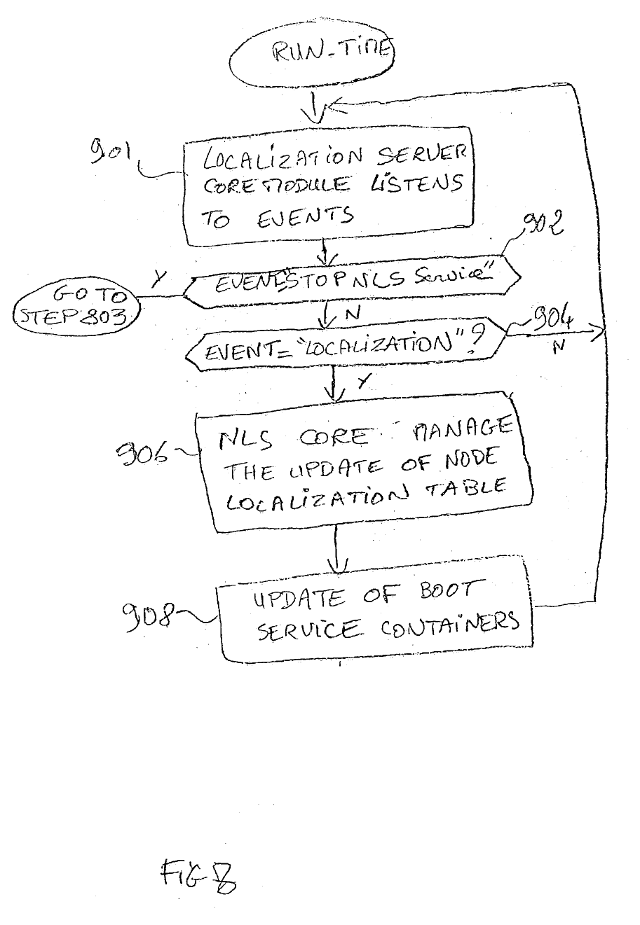

FIG. 8 illustrates the node location server during run-time, following the start-time of the flowchart of FIG. 7, according to an embodiment of the present invention. After the operations of FIG. 7 have completed, NLS core is managing administration events coming from NLS availability daemon like “stop the NLS service” in case of master switch-over event. In this case, at operation 902, the flowchart continues at operation 803 of FIG. 7. NLS core is also managing administration events coming from NLS availability daemon like “hang-up NLS service”, which means re-starting from a table NLT located on the mirrored disk, as the NLT may have been modified by an administrator. NLS core starts also listening to location events at operation 904 coming from node location manager, such as a location event informing about the new hardware identifier for a given location identifier in this case, the NLS core manages the update of the NLT table according to changes of hardware identifier for a given location identifier (or a given node identifier). The NLS core is also adapted to update the DHCP containers according to the new NLT table. The hang-up event will lead to a complete re-generation of NLT table from persistent storage, that is, from the disk.

FIGS. 9 and 10 illustrate a method to retrieve node location of the Ethernet switch SNMP manager 241, according to embodiments of the present invention. In the following description, the “manager module” represents the Ethernet switch SNMP manager 241 of the master node.

In FIG. 9, the process is aimed to build a local table of at least data couples indicating port identifier/hardware identifier, according to an embodiment of the present invention. In operation 601, the manager module requests an agent module of a switch designated with its identifier (e.g., IP address of the switch, or the name of the switch) for the status of a given port designated with its' port identifier (e.g., its port number). At operation 602, the agent module having retrieved this port status, sends the port status and other additional information to the manager module of the master node.

If the port status indicates that the port is up and that a node is connected to this port and its hardware identifier is known at operation 604 (“learned”), the manager module may request the agent module to determine this hardware identifier at operation 608. The agent module may retrieve this information in a Management Information Base implemented in the agent module and sends it to the manager module.

At operation 610, the manager module retrieves the hardware identifier corresponding to the port number and stores the data couple in a table, this data couple indicating at least the hardware identifier and the port identifier. At operation 610, a data couple corresponding to the same port identifier may be already stored in the table. In this case, the retrieved hardware identifier (new node identifier) and the hardware identifier already stored in the table (old hardware identifier) are compared and responsive to a difference between them, the old hardware identifier is replaced by the new hardware identifier: the data couple in the table is thus updated. If other ports may be requested by the manager module at operation 612, the process returns to operation 601, else it ends.

If the port status indicates that the port is down, or if the port status indicates that a node is connected to this port and without indicating that the hardware identifier is known (or indicating that the hardware identifier is not known) at operation 604, the manager module may restart operations 601 to 604 for this port. The manager module restarts operations 601 to 604 for this port until the port status is up at operation 604 or until at operation 605 the manager module has restarted R consecutive times operations 601 to 604 for this port, R being an integer greater than 1. In this last case, the flowchart continues at operation 612.

The flowchart of FIG. 9 may be repeated regularly to request for hardware identifier connected to a port identifier in order to update the table and to maintain a current table.

A manager module may execute the flowchart of FIG. 9 in parallel for different ports in an agent module or in several agent modules, thus having an local table for each switch.

FIG. 10 illustrates a process of updating the table port and node information, according to an embodiment of the present invention. In FIG. 10, a modification of the status of a port may appear in the switch, that is to say, a node having a down status may change to an up status and reciprocally. In this case, an agent module sends a trap( ) function, as described hereinbefore, in operation 702. The manager module receives then this trap at operation 704. If the port status indicates the value up, at operation 710 the flowchart continues in FIG. 9 operation 601 to build a new version of its local table. For an already stored data couple in the manager module's memory, the manager module retrieves the hardware identifier for the port and updates the already stored data couple in operation 610 of FIG. 9. If the port status indicates the value down at operation 706, the data couple in the manager module's memory is invalidated at operation 708. After operations 708 or 710, the flowchart ends.

At operation 704, if some differences are found between the old and the new version of the local table, the node location handler notifies the NLS core by calling the callback function previously registered, giving in argument a couple of information (locID, hardwareID), where locID may be portNumber subnet and hardwareld may be the MAC address. The NLT table is thus updated.

The invention is not limited to the hereinabove embodiments. Thus, the table of the manager module's memory may comprise other columns or information concerning for example the time at which the information for the port and the connected node is retrieved. The manager module may regularly request for information such as the port status and the node identifier connected to this port. The manager module may define a period of time to retrieve the information. In an embodiment, the table may also indicate all the ports and their status. If the node has a down status or if it is not identified, the column C2 is empty. This enables the manager module, the node having the manager module, or a user requesting this node, to have a sort of map for ports of a switch and to know to which port the node is connected.

If the port of a node is down, this port status is indicated in the table and the node connected to this port may be changed and may be connected to another port having an up status.

The invention is not limited to the hereinabove features of the description.

The node location manager 222 may comprise the node location handler 232.

Though the description is based on the DHCP server, other services may be managed by the node location server according to the invention. Moreover, the description is based on nodes interconnected with switches having ports. The invention is also applicable to nodes interconnected on cPCl buses having slots, the hardware identifier being for example a string.

The invention also covers a software product comprising the code for use in the manager server of the invention.

The preferred embodiment of the present invention a method and system of node location manager in a distributed computer system, is thus described. While the present invention has been described in particular embodiments, it should be appreciated that the present invention should not be construed as limited by such embodiments, but rather construed according to the below claims.

What is claimed, is:

1. A management server of a distributed node system comprising:
a table manager adapted to load a first table comprising for ones of a plurality of node identifiers: a location identifier, a hardware identifier, and configuration parameters;
a node location manager adapted to detect a new hardware identifier for a location identifier and to send a modification message to the table manager, said modification message comprising the new hardware identifier for a location identifier, the table manager being adapted to update the first table responsive to said modification message; and
a client manager adapted to generate at least a second table in a client server according to the first table and to update said second table when the first table is updated.

2. The management server of claim 1, wherein the node location manager is operative in a dynamic node location mode.

3. The management server of claim 1, wherein the node identifier comprises a number different for each node of the distributed node system.

4. The management server of claim 1, wherein, in a static node location mode, the location identifier comprises an Internet Protocol.

5. The management server of claim 1, wherein, in a dynamic node location mode, the location identifier comprises a port number, a node being attached to the corresponding port, and an Internet Protocol address.

6. The management server of claim 1, wherein the hardware identifier comprises the Ethernet address of a node in the distributed node system.

7. The management server of claim 1, wherein, in a dynamic node location mode and nodes being attached to ports of a switch in the distributed node system, the node location manager is further adapted, at initialization time, to request port status for port numbers and to retrieve port status indication for said port numbers.

8. The management server of claim 1, wherein, in the dynamic node location mode and nodes being attached to ports of a switch in the distributed node system, the node location manager is further adapted to receive a message comprising a modified port status indication.

9. The management server of claim 7, wherein, responsive to port status meeting a given condition, the node location manager is further adapted to retrieve a hardware identifier of a node connected to a port having said given condition.

10. The management server of claim 9, wherein the given condition comprises port status of “up” and indicates that the hardware identifier of the node connected to said port is known.

11. The management server of claim 1, wherein the node location manager is substantially compliant with the SNMP protocol and is further adapted to establish a connection with an agent of the switch that is substantially compliant with the SNMP protocol.

12. The management server of claim 1, wherein the client server comprises a server substantially compliant with the DHCP protocol.

13. The management server of claim 1, wherein the client manager is further adapted to generate the Internet Protocol address of nodes using the network Internet Protocol address and to generate at least the second table using the Internet Protocol address of the nodes, the corresponding hardware identifier of the first table and the configuration parameters.

14. The management server of claim 1, wherein the hardware identifier is a slot identifier configured at initialization time.

15. A method of node location management in a distributed node system comprising:
a) loading a first table comprising for ones of a plurality of node identifiers: a location identifier, a hardware identifier, and configuration parameters;
b) detecting a new hardware identifier for a location identifier;
c) updating the first table responsive to the new hardware identifier for the location identifier; and
d) generating at least a second table in a client server according to the first table and updating said second table when the first table is updated.

16. The method of claim 15, wherein said b) and c) are operative in a dynamic node location mode.

17. The method of claim 15, wherein the node identifier of said a) comprises a number different for each node of the distributed node system.

18. The method of claim 15, wherein, in a static node location mode, the location identifier comprises an Internet Protocol address.

19. The method of anyone of claim 15, wherein, in a dynamic node location mode, the location identifier comprises a port number, a node being attached to the corresponding port, and an Internet Protocol address.

20. The method claim 15, wherein the hardware identifier comprises the Ethernet address of a node in the distributed node system.

21. The method of claim 15, wherein, in a dynamic node location mode and nodes being attached to ports of a switch in the distributed node system, said b) comprises, at initialization time, requesting port status for port numbers and receiving port status indication for said port numbers.

22. The method of claim 15, wherein, in a dynamic node location mode and nodes being attached to ports of a switch in the distributed node system, said b) comprises receiving a message comprising a modified port status indication.

23. The method of anyone of claim 21, wherein said b) further comprises:
b1) responsive to ones of said port status meeting a given condition, retrieving a hardware identifier of a node connected to ports having said given condition.

24. The method of claim 23, wherein the given condition of said b1) comprises that the port status is “up” and indicates that the hardware identifier is known.

25. The method of claim 15, wherein said b) comprises establishing a connection with an agent of a switch in said distributed node system in a manner that is substantially compliant with the SNMP protocol.

26. The method of claim 15, wherein the client server of said d) comprises a server that is substantially compliant with the DHCP protocol.

27. The method of claim 15, wherein said d) comprises generating the Internet Protocol address of nodes in said distributed node system using the network Internet Protocol address and generating at least the second table using the Internet Protocol address of the nodes, the corresponding hardware identifier of the first table and the configuration parameters.

28. The method of claim 15, wherein the hardware identifier is a slot identifier configured at initialization time.

29. A computer readable medium having stored therein instructions which when executed on a computer readable medium implement a method of node location management in a distributed node system, said method comprising:
a) loading a first table comprising for ones of a plurality of node identifiers: a location identifier, a hardware identifier, and configuration parameters;
b) detecting a new hardware identifier for a location identifier;
c) updating the first table responsive to the new hardware identifier for a location identifier; and
d) generating at least a second table in a client server according to the first table and updating said second table when the first table is updated.

30. The computer readable medium of claim 29, wherein said b) and c) of said method are operative in a dynamic node location mode.

31. The computer readable medium of claim 29, wherein the node identifier of said a) of said method comprises a number different for each node of the distributed node system.

32. The computer readable medium of claim 29, wherein, in a static node location mode, the location identifier comprises an Internet Protocol address.

33. The computer readable medium of claim 29, wherein, in a dynamic node location mode, the location identifier comprises a port number, a node being attached to the corresponding port, and an Internet Protocol address.

34. The computer readable medium of claim 29, wherein the hardware identifier comprises the Ethernet address of the node in the distributed node system.

35. The computer readable medium of claim 29, wherein, in a dynamic node location mode and nodes being attached to ports of a switch in the distributed node system, said b) of said method comprises, at initialization time, requesting port status for port numbers and receiving port status indication for said port numbers.

36. The computer readable medium of claim 29, wherein, in a dynamic node location mode and nodes being attached to ports of a switch in the distributed node system, said b) of said method comprises receiving a message comprising a modified port status indication.

37. The computer readable medium of claim 35, wherein said b) of said method comprises:
b1) responsive to ones of said port status meeting a given condition, retrieving a hardware identifier of the node connected to ports having said given condition.

38. The computer readable medium of claim 37, wherein the given condition of said b1) of said method comprises that the port status is “up” and indicates that the hardware identifier is known.

39. The computer readable medium of claim 29, wherein said b) of said method comprises establishing a connection with an agent of a switch in said distributed node system in a manner that is substantially compliant with the SNMP protocol.

40. The computer readable medium of claim 29, wherein the client server of said d) of said method comprises a server that is substantially compliant with the DHCP protocol.

41. The computer readable medium of claim 29, wherein said d) of said method comprises generating the Internet Protocol address of nodes in said distributed node system using the network Internet Protocol address and generating at least the second table using the Internet Protocol address of the nodes, the corresponding hardware identifier of the first table and the configuration parameters.

42. The computer readable medium of claim 29, wherein the hardware identifier is a slot identifier configured at initialization time.
